(19) United States
(12) Patent Application Publication
(10) Pub. No.: US 2026/0228948 A1
(43) Pub. Date: Aug. 6, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Wataru MATSUURA, Kanagawa (JP)

(21) Appl. No.: 19/457,272

(22) Filed: Jan. 23, 2026

(30) Foreign Application Priority Data
Feb. 3, 2025 (JP) 2025-016286

(51) Int. Cl. G06T 11/60; G06F 40/279; G06F 40/40

(52) U.S. Cl. CPC G06T 11/60; G06F 40/279; G06F 40/40

(57) ABSTRACT

An information processing apparatus comprises a determination unit configured to determine whether a generation result from generative AI processing is inappropriate; an adjustment unit configured to adjust an input to the generative AI processing based on a determination result of the determination; and a regenerative unit configured to cause the generative AI processing to perform regeneration using the adjusted input to obtain a regeneration result.

### BACKGROUND

### Field of the Technology

The present disclosure relates to generative AI processing.

### DESCRIPTION OF THE RELATED ART

With recent advances in AI processing technology, a technology called generative AI has been developed in which a learning model is generated by performing training using various data, and data is provided to the learning model as input in order to generate and alter various content. For example, an image-generating AI that generates a new image when a text prompt (hereafter, “prompt”) is provided to a model trained on many images, a generative AI capable of chatting as if conversing in response to a provided prompt, and similar technologies have been developed. Generative AI can also generate video, audio, program code, and the like. In this way, users can generate various content using generative AI.

When using such generative AI, for example, an image-generating AI receives a prompt as input and generates an image as a generation result. However, it is difficult for users to accurately check in advance whether a desired result will be generated from the input prompt. Thus, the user cannot determine whether the generation result is inappropriate, and may incorrectly use the generation result.

The technology of Japanese Patent Laid-Open No. 2024-043428 determines a similarity between a generation result from a first machine learning model and an existing object, such as a copyrighted work, by using a second machine learning model. If the similarity is greater than or equal to a threshold, a third machine learning model regenerates a result such that the similarity to the existing object is less than or equal to the threshold value.

However, the above technology requires preparing the third machine learning model for regeneration separately from the first machine learning model.

### SUMMARY

The present disclosure in its first aspect provides an information processing apparatus comprising: a determination unit configured to determine whether a generation result from generative AI processing is inappropriate; an adjustment unit configured to adjust an input to the generative AI processing based on a determination result of the determination; and a regenerative unit configured to cause the generative AI processing to perform regeneration using the adjusted input to obtain a regeneration result.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 shows an example hardware configuration of an information processing apparatus according to an embodiment.

FIG. 2 is a block diagram illustrating functionality of the information processing apparatus according to a first embodiment.

FIG. 3 is a flowchart illustrating processing for regenerating a generation result according to the first embodiment.

FIG. 4 is a flowchart of processing for adjusting an input in S302 executed by an adjustment unit according to the first embodiment.

FIG. 5 is a block diagram illustrating functionality of an information processing apparatus according to modification 2.

FIG. 6 is a flowchart illustrating a flow of processing for regenerating a generation result according to modification 2.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

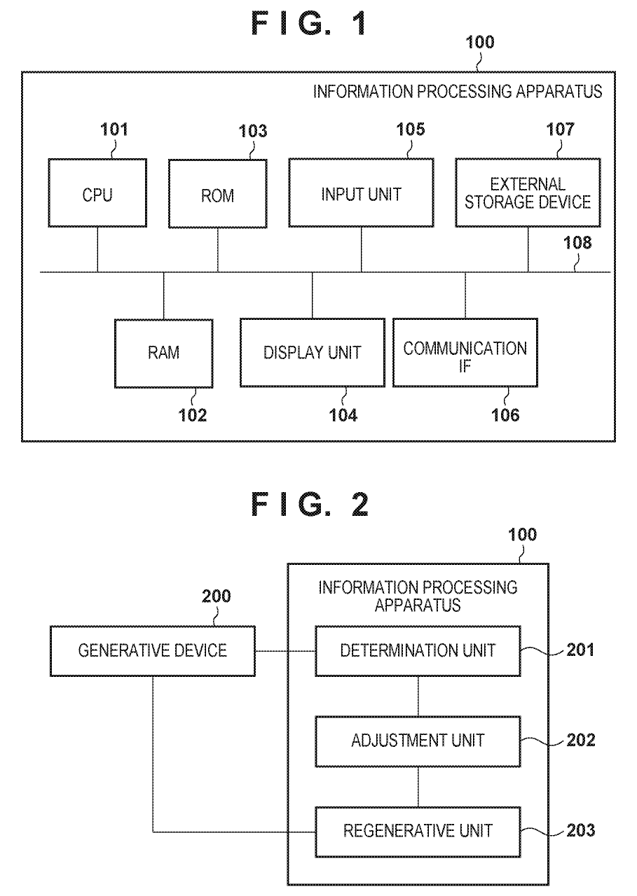

FIG. 1 shows an example hardware configuration of an information processing apparatus according to an embodiment. An information processing apparatus 100 may be a computer. The information processing apparatus 100 includes a CPU 101, a RAM 102, a ROM 103, a display unit 104, an input unit 105, a communication IF 106, an external storage device 107, and a bus 108. The CPU 101, the RAM 102, the ROM 103, the display unit 104, the input unit 105, the communication IF 106, and the external storage device 107 are communicably connected to each other by the bus 108 or the like.

The CPU 101 is a central processing unit, i.e., a processor. The CPU 101 controls the overall information processing apparatus 100. Instead of or in addition to the CPU 101, the information processing apparatus 100 may include another processor such as a micro processing unit (MPU), a graphics processing unit (GPU), a neural processing unit (NPU), or a quantum processing unit (QPU).

Some or all of the functions of the information processing apparatus 100 are implemented by one or more processors, including the CPU 101, reading a computer program (hereinafter also referred to as a program) stored in the ROM 103, the external storage device 107, or the like, and loading the program into the RAM 102 and executing the program. The information processing apparatus 100 may also have a plurality of processors of the same type, and respective processors may implement different functions. For example, the CPU 101 may control image display by controlling the display unit 104. The CPU 101 may control the information processing apparatus 100 in order to realize an operation corresponding to user input. Some or all of the functions of the information processing apparatus 100 may be implemented by one or more circuits, such as an application specific integrated circuit (ASIC) and a programmable logic device (PLD) including a field programmable gate array (FPGA).

The RAM 102 is a random access memory, which is a memory capable of rapidly reading and writing data. The RAM 102 functions as a working area for the CPU 101 to execute a program. The RAM 102 stores data of an obtained generation result, image data to be displayed on the display unit 104, and the like. The RAM 102 may have a storage capacity sufficient to store a predetermined number of still images, and video for a predetermined time. The RAM 102 may also serve as a memory (video memory) for image display. In this case, the RAM 102 supplies display data to the display unit 104.

The ROM 103 is a read only memory, and is a nonvolatile storage device such as a magnetic storage device or a semiconductor memory. The ROM 103 stores programs and the like to be loaded by the CPU 101.

The display unit 104 may be a display device for displaying images, such as a liquid crystal display. The display unit 104 displays images that includes various data and processing results to the user.

The input unit 105 may include input devices such as switches, buttons, keys, a touch panel, and a keyboard. Upon receiving user input, the input unit 105 outputs the input to the CPU 101 via the bus 108.

The communication IF 106 is an interface for communicating with external devices via a network. The communication IF 106 communicates through, for example, a local area network (LAN) or a wide area network (WAN).

The external storage device 107 is a nonvolatile storage device that can be read from and written to by the CPU 101, and stores programs, data, and the like. The external storage device 107 may be, for example, a hard disk, a solid state drive (SSD), or a memory card installed in the information processing apparatus 100. The external storage device 107 may also be, for example, a flexible disk (FD), an optical disk such as a compact disc (CD), a magnetic or optical card, an IC card, or a memory card removable from the information processing apparatus 100. Note that the external storage device 107 may be installed inside the information processing apparatus 100.

### First Embodiment

The information processing apparatus 100 according to the present embodiment adjusts an input to a machine learning model trained for generative AI processing to generate an image, and inputs the adjusted input to the same generative AI processing model (hereinafter also referred to as a “generative AI model” or “machine learning model”). With this configuration, the present embodiment suppresses generation of inappropriate generation results without preparing a separate regeneration model. As a result, the present embodiment suppresses an increase in the number of models and reduces the effort required for the user to check the generation results. Note that “AI” stands for artificial intelligence.

In the following description of the present embodiment, an example is used in which the information processing apparatus 100 according to the first embodiment is applied to a situation where an image is generated using a diffusion model as a generative AI processing model. In the present embodiment, adjusted generation conditions are input to the diffusion model to generate and output different images.

FIG. 2 is a functional block diagram illustrating functionality of the information processing apparatus 100 of an information processing system according to the first embodiment. The information processing system includes the information processing apparatus 100 and a generative device 200. The information processing apparatus 100 is connected to the generative device 200 so that data such as generated image data and instructions related to regeneration can be transmitted and received between them.

The generative device 200 uses a diffusion model to generate a generation result such as an image by performing generative AI processing on an input such as a prompt transmitted by the information processing apparatus 100. In response to an instruction from the information processing apparatus 100, the generative device 200 regenerates a generation result by performing generative AI processing on the adjusted input using the same model. In the following description, a generation result obtained by regeneration may also be referred to as a “regeneration result”. Furthermore, the term "generation result" may also include a regeneration result. The generative device 200 may be separate from or integrated with the information processing apparatus 100. The generative device 200 may have the same hardware configuration as the information processing apparatus 100.

The information processing apparatus 100 includes a determination unit 201, an adjustment unit 202, and a regenerative unit 203. Some or all of the determination unit 201, the adjustment unit 202, and the regenerative unit 203 may be implemented by the CPU 101 loading and executing a program.

The determination unit 201 obtains a generation result of generative AI processing performed by the generative device 200 and determines whether the generation result is inappropriate. The definition of the term “inappropriate generation result” will be described later.

The adjustment unit 202 adjusts an input for generative AI processing performed by the generative device 200, based on a determination result by the determination unit 201. The input adjusted by the adjustment unit 202 is, for example, a prompt. The adjustment unit 202 may determine at least one of an adjustment item and an adjusting method for adjusting an input.

The regenerative unit 203 instructs the generative device 200 to perform generative AI processing to regenerate a generation result based on the input adjusted by the adjustment unit 202, thereby causing the generative device 200 to regenerate a generation result. Thus, the regenerative unit 203 obtains the generated regeneration result from the generative device 200.

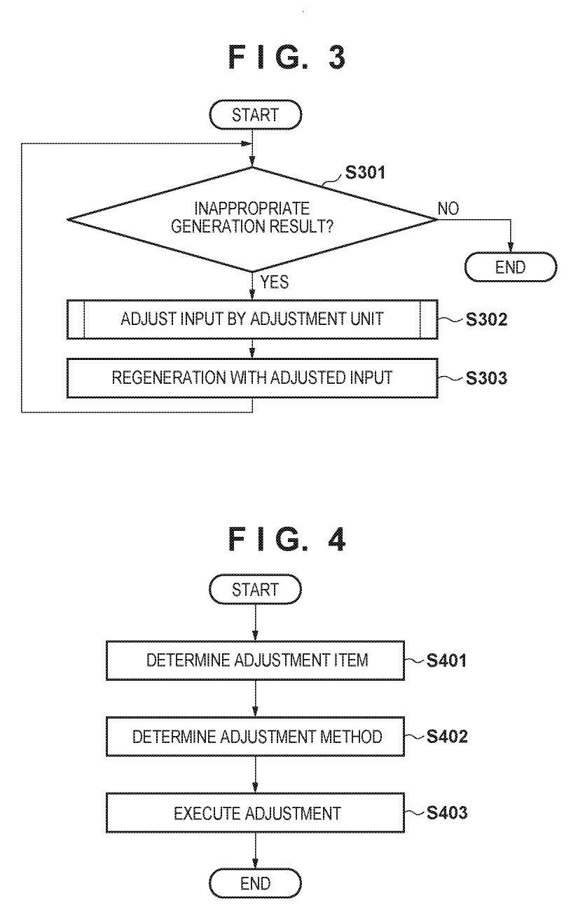

FIG. 3 is a flowchart illustrating a flow of processing for regenerating a generation result according to the first embodiment. The flow of the regeneration processing according to the present embodiment will be described with reference to FIG. 3. The following description omits notation of processes (steps) by representing each process (step) with an identifier starting with “S”. Note that it is not always necessary for the information processing apparatus 100 to perform all the processes illustrated in this flowchart. Processing executed by the CPU 101 is shown as functional blocks.

Before the regeneration processing is executed, for example, the user may transmit, via the information processing apparatus 100, a prompt or the like as input to the generative device 200 to cause the generative device 200 to generate a generation result.

In S301, the determination unit 201 determines whether a generation result obtained from the generative device 200 is inappropriate. An inappropriate generation result may be an image that includes any of the following: violent images, indecent images, or discriminatory images that incite hatred toward particular races and religions. Other examples of inappropriate images may include images showing the face or appearance of a specific person, images that include personal information from which a specific person can be identified, and images that include trademarks or copyrighted works, such as specific logos or character images. The determination unit 201 may regard any of the above-listed or similar images as inappropriate generation results because such images lead to output of generation results that raise infringement concerns or that are inconsistent with the facts.

The determination unit 201 may use a model that is machine-trained in advance to determine whether the generation result from the generative device 200 corresponds to any of those inappropriate generation results. For example, the model may be a trained model that has been pre-trained using machine learning for an image classification task to determine whether an image is inappropriate. The trained model can thereby output a probability value indicating whether an input image is inappropriate as a continuous value (e.g., a continuous value from 0 to 1).

A threshold value for judging a probability value output by the model is set in advance such that it can be determined whether the generation result is inappropriate. The threshold value may be, for example, 0.5. Thus, the determination unit 201 can determine whether the generation result is inappropriate based on whether the probability value output when the generation result from the generative device 200 is input to the image classification model exceeds the threshold value. Note that either the output probability value or classification result information may also be used in input adjustment processing in S302. The details of S302 will be described later.

The machine learning model used by the determination unit 201 may be a model trained for tasks other than image classification, or may be a combination of a plurality of models. For example, the machine learning model used by the determination unit 201 may be a model pre-trained using machine learning for an object detection task to detect trademarks and copyrighted works. Object detection is a task that detects specific objects in an image and outputs the estimated position and size of the detected object as a rectangle (bounding box). For example, the object detection model performs object detection on the generation result from the generative device 200, and if an inappropriate generation result is detected in the image, the determination unit 201 can determine that the generation result is inappropriate.

When an inappropriate generation result is included in an area of the image, object detection enables more appropriate determination than image classification in which determination is performed based on context of the entire image. In addition, by further classifying an image with an image classification model after an object detection model has performed at least either cropping or resizing an object detection area, more accurate determination can be made than when determination is made with object detection alone.

The determination unit 201 may weight the determination result in accordance with the position, size, and number of objects detected in the image, and output the weighted determination result to the adjustment unit 202. The adjustment unit 202 may execute input adjustment processing in S302 based on the weighted determination result.

The determination unit 201 may output the proportion of the image occupied by the area of the inappropriate generation result to the adjustment unit 202, and the adjustment unit 202 may perform the input adjustment processing in S302 based on this proportion.

In addition to the object detection model, the determination unit 201 may perform the determination using a generative AI model trained using machine learning to generate an output result based on either an image or a sentence. For example, this model may be a multimodal generative AI model or the like separate from the generative device 200. The multimodal generative AI model receives as input an image of the generation result from the generative device 200, a definition of inappropriate generation results, a specific determination method for them, and a prompt specifying the output format of a determination result. By inputting the received prompt or the like to the multimodal generative AI model, the determination unit 201 may obtain, for example, a Boolean value as a determination result indicating whether the image is inappropriate as an output result. The definition of inappropriate generation results may be, for example, the aforementioned definition, and may be provided by an administrator different from the user (e.g., when the user is a child, a guardian of the user). Thus, the administrator manually sets and adds the definition of inappropriate generation results, and the determination unit 201 can thereby determine whether the generation result is inappropriate based on determination criteria corresponding to the user's use condition.

The determination unit 201 uses the above-described determination method to determine whether the generation result from the generative device 200 is inappropriate. If the generation result is determined to be inappropriate, processing then proceeds to S302. On the other hand, if the generation result is determined to be not inappropriate, the determination unit 201 may end the processing.

In S302, the adjustment unit 202 adjusts the input used to generate the generation result that was determined to be inappropriate in S301 for regeneration. In the present embodiment, the input adjusted by the adjustment unit 202 may be a prompt.

FIG. 4 is a flowchart illustrating the flow of adjustment processing in S302 performed by the adjustment unit 202.

In S401, the adjustment unit 202 determines an adjustment item for the input used by the generative device 200 to generate the generation result. The adjustment item is an item indicating what to adjust in the input, such as a part of the input, the number of inputs, and the number of objects to be adjusted included in the input. The adjustment item can also be referred to as an adjustment target of the input. In this embodiment, the adjustment item is, for example, one or more words included in the input prompt. Note that if the input prompt is not divided into one or more words in advance, that is, if the prompt is a sentence, the adjustment unit 202 may perform a morphological analysis to divide the sentence into words.

The adjustment unit 202 may determine an adjustment item based on similarity between features of the generation result and features of the input. More specifically, the adjustment unit 202 may determine an adjustment item based on the result of calculating similarity between features of one or more words in the input prompt and features of the generated image. The reason the adjustment unit 202 compares similarities is that a word in a prompt whose features are similar to those of the generation result determined to be inappropriate in S301 is likely a factor in this determination. That is, that word is considered to be an inappropriate input. The concept of inappropriate input may be the same as that of inappropriate generation results described in S301. Thus, the adjustment unit 202 may determine violent words, indecent words, discriminatory expressions, proper nouns representing specific people, and the like to be inappropriate inputs. Note that the description of inappropriate input overlaps the description of S301, and therefore the details are omitted.

The adjustment unit 202 may calculate the similarity using cosine similarity between features. The features of the input and the generation result may be numerical data in a vector form, such as a multidimensional vector form. For example, the adjustment unit 202 may extract features using a multimodal AI model trained on pairs of images and prompt text to learn their associations. The adjustment unit 202 may directly calculate the cosine similarity between the features by mapping those extracted from the image and those extracted from a text prompt into a common embedding space. For the multimodal AI model for extracting features, the technology of the Alec Radford literature (Alec Radford, and eleven others, "Learning Transferable Visual Models from Natural Language Supervision" <URL:https://arxiv.org/pdf/2103.00020>) may be applied. Thus, the adjustment unit 202 may extract features of the generation result from the generative device 200 and features of words in the prompt.

The adjustment unit 202 may extract one feature extracted from a combination of two or more words as a feature of the words in the prompt. When the prompt includes n words, the number of combinations of all words is 2^n-1. The reason for combining words is that the input may be inappropriate depending on the combination. Therefore, the adjustment unit 202 can determine an adjustment item more appropriately by comparing similarities between a plurality of features extracted from the combinations of words and features of the generated image.

In accordance with the above processing, the adjustment unit 202 may determine, as an adjustment item, a word or a combination of words in the prompt that has the highest feature similarity with the generated image as a result of comparing the similarities between the features of the words or the combinations of words in the prompt with the features of the generated image. Note that a threshold value may be set in advance for the similarity, and the adjustment unit 202 may determine all words in the prompt whose similarity is greater than or equal to the threshold value as adjustment items.

The adjustment unit 202 may perform preprocessing on the generation result and the regeneration result to generate text before extracting features. Hereinafter, the generation result and the regeneration result may be referred to collectively as a “generation result or the like”. The adjustment unit 202 may perform preprocessing using a model trained using machine learning in advance. A machine learning model for preprocessing may be, for example, an image captioning generative AI model that receives an image as input, understands the content of the input image, and generates explanatory text in natural language text format for the generation result or the like based on that understanding. The machine learning model for preprocessing may be a generative AI model separate from the generative device 200. The machine learning model for preprocessing performs preprocessing to generating a caption or explanatory text that explains the input image, with the generation result or the like from the generative device 200 as input. The machine learning model for preprocessing may output a caption that contains one or more words, and may perform morphological analysis on the generated explanatory text to divide it into words and output these words. The adjustment unit 202 may extract features from the generation result or the like, based on the above-described method, using one or more words included in the caption or the like obtained by the preprocessing. The adjustment unit 202 may calculate cosine similarity between the features extracted from, for example, the caption or the like for the generation result or the like and the features of each word in the prompt used by the generative device 200 to generate the generation result. The adjustment unit 202 may determine, based on the cosine similarity, one or more words in the prompt that have the highest similarities to the features of the caption as adjustment items. Note that the adjustment unit 202 may calculate the cosine similarity using a combination of words included in the caption.

The adjustment unit 202 may determine in advance whether words in the obtained caption are inappropriate, and may determine an adjustment item based on the determination result. The determination method may follow a similar approach to the processing in S301. For example, the adjustment unit 202 may perform the determination using a trained machine learning model that receives at least one of a caption, explanatory text, and words as input and determines whether the input is inappropriate. The adjustment unit 202 determines, as an adjustment item, a prompt whose features have the highest similarity to those of the caption, word, or the like determined to be inappropriate, thereby enabling more accurate identification of an inappropriate prompt based on the appearance of the image.

The adjustment unit 202 may determine the number of input adjustment items based on the above-described similarity. Note that the upper limit of the number of inputs may be set in advance. Alternatively, the adjustment unit 202 may determine the number of input adjustment items based on information obtained by the information processing apparatus 100. In the present embodiment, the number of inputs may be, for example, the number of words and the number of sentences. The larger the number of inputs, the more specific expressions the prompt can include, and it is therefore considered that the likelihood of the generation result being inappropriate increases with the number of inputs. Accordingly, for example, if an input prompt contains 20 words, the adjustment unit 202 may adjust the input by restricting the number of input words to 10. A specific means for determining the number of inputs will be described later.

In addition, the adjustment unit 202 may determine the adjustment item based on any of user attributes (including age, sex, and language), location information on the user or the like, information obtained by the information processing apparatus 100, such as a date and time. The adjustment unit 202 may obtain one piece of information in advance, and may combine a plurality of pieces of the obtained information. Also, the adjustment unit 202 may weight information that is given priority or regarded as important based on the combination. The adjustment unit 202 may obtain, for example, pre-registered user attributes by performing login authentication for the user before performing the processing in S401. As a result, for example, if the user is at or below a predetermined age, the adjustment unit 202 may determine the number of input words to be five or less as an adjustment item.

When the adjustment unit 202 obtains location information and area information (country, city, town, village, etc.) on an access source based on information such as an IP address, the adjustment unit 202 may determine, as an adjustment item, a combination of specific proper nouns, words, or similar elements associated with religion, culture, or the like that are taboo in the area indicated by the information. Consider the case in which the adjustment unit 202 obtains the current location information using Global Navigation Satellite System (GNSS), Wi-Fi, a mobile network, or the like. The adjustment unit 202 appropriately sets a time zone based on the location information. In this case, the adjustment unit 202 may determine, as an adjustment item, a combination of a specific proper noun and words (e.g., specific party name, candidate name) on a predetermined date and time or during a predetermined period (e.g., election period). Regarding specific proper nouns, a database related to inappropriate generation results may be prepared in advance for each target area, and the adjustment unit 202 may switch the database in accordance with the obtained area information. The database may be created by a manager of the user, or may be based on a database created by another person. When a specific word included in the input matches a word in the database, the adjustment unit 202 may determine the matching specific word as an adjustment item.

In the case of a generative method in which the generative device 200 repeats interactive generation, the adjustment unit 202 may obtain information (meta information) that is not directly provided as input, such as the previous interaction history. In this case, the adjustment unit 202 may determine an adjustment item based on the obtained information. For example, there are cases where interactive generative AI performs generation based on the previous output result. Thus, including directives in a prompt can make the prompt an ambiguous instruction. In such cases, unintended generation results and inappropriate generation results may be output. Therefore, the adjustment unit 202 may obtain the number of times of interaction by the generative device 200 in advance as meta information. If the number of times of interaction indicated by the obtained meta information is greater than or equal to a predetermined number, the adjustment unit 202 may determine a specific directive as an adjustment item.

As described above, the adjustment unit 202 determines an adjustment item for the input based on similarity between features and obtained information. The adjustment unit 202 thereby completes the processing for determining an adjustment item in S401.

In S402, the adjustment unit 202 determines an adjustment method for the adjustment item for the input. Based on the adjustment item determined in S401, the adjustment unit 202 may determine a method for adjusting the adjustment item. The adjustment method may be, for example, suppression or change of the adjustment item. The adjustment method in the present embodiment is suppressing the adjustment item by deleting one or more words in the prompt. Note that if two or more adjustment items have been set in S401, the adjustment unit 202 may delete all of the adjustment items.

Further, as an adjustment method other than deletion, the adjustment unit 202 may change the adjustment item. For example, the adjustment unit 202 may search an external database or the like for synonyms of a word that is the adjustment item. If one or more synonyms are obtained from the search results, the adjustment unit 202 may extract features of the obtained synonyms as in S401. The adjustment unit 202 calculates the cosine similarity of the extracted features and the word that is the adjustment item determined in S401, as in S401. The adjustment unit 202 may replace the word that is the adjustment item with a synonym having the lowest similarity among the synonyms for which the calculation result is below a predetermined threshold value. By this replacement, the adjustment unit 202 can use a synonym having a low cosine similarity to the original word as a word with which an inappropriate generation result is unlikely to be generated, without impairing the meaning intended by the original word.

If it is determined in S401 that the number of inputs is determined as an adjustment item, the adjustment unit 202 may change the upper limit of the number of inputs to a predetermined value based on a threshold value set in advance. For example, if the threshold value of the number of input words in the prompt is 20, the adjustment unit 202 may restrict the upper limit to 15 words. The adjustment unit 202 may restrict the upper limit to an integer less than or equal to half the number of words in the original prompt. For example, if 20 words are input, the adjustment unit 202 may restrict the upper limit of the number of input words to 10.

The adjustment unit 202 may also determine the number of inputs based on the result of S301. For example, if, in S301, a model trained using machine learning for an image classification task determines whether the generation result is inappropriate, a probability value indicating whether the generation result is inappropriate is obtained as an output of the model. In this case, the adjustment unit 202 may perform adjustment so as to reduce the number of inputs in accordance with the probability value. For example, it is assumed that probability values are obtained as continuous values from 0 to 1. In this assumption, the adjustment unit 202 may limit the number of inputs to 10 words if the probability value is 0.8, and may limit the number of inputs to five words if the probability value is 0.9. By limiting the number of inputs in accordance with the probability value, the adjustment unit 202 can change the degree of adjustment of the prompt in accordance with the degree of inappropriateness.

If, in S301, a model trained using machine learning for an object detection task determines whether the generation result is inappropriate, the adjustment unit 202 may restrict the number of inputs in accordance with at least one of the position, size, and number of detected inappropriate objects. For example, if the position at which an inappropriate object is detected is at an end of the image, the adjustment unit 202 may limit the number of input words to 10. Further, if the proportion of the size of a detected object to the size of the image is greater than or equal to a predetermined threshold value, the adjustment unit 202 may restrict the number of input words to five. How to restrict the input may be set in advance by the user or the like, or may be determined by the adjustment unit 202 in accordance with the detection result based on a predetermined priority.

If only the number of inputs is determined as the adjustment item in S401, the adjustment unit 202 may manually change or re-input the number of inputs after presenting the upper limit of the number of inputs to the user. Conversely, a case is also possible in which the number of inputs or the like set by the adjustment unit 202 conflicts with the upper limit of the number of inputs set in the processing in S402, as in the case where the adjustment item is determined in S401 based on similarity between features. In this case, the adjustment unit 202 may give priority to the adjustment item set in advance, and may determine the adjustment item based on the aforementioned user attributes or the like. For example, the adjustment unit 202 selects 10 words from 20 words in the prompt in the order of lower similarity as adjustment items, based on the result of calculating the similarity between features in S401 described above. In this case, if the adjustment unit 202 determines in S402 that the upper limit of the number of inputs is restricted to five, a conflict occurs between 10 words and five words. In this case, by configuring a setting in advance to give priority to the upper limit of the number of inputs, the adjustment unit 202 may determine an adjustment method so as to select five words in the ascending order of the similarity between features.

In S403, the adjustment unit 202 adjusts the input based on the adjustment item determined in S401 and the adjustment method determined in S402. For example, the adjustment unit 202 executes the adjustment by deleting one or more words from the prompt. Thus, the adjustment unit 202 completes prompt adjustment processing in S302.

In S303, the regenerative unit 203 causes the generative AI of the generative device 200 to regenerate a generation result with the input adjusted in S302. The generative AI used for regeneration is the generative AI that has generated the generation result obtained in S301. The regenerative unit 203 may, for example, use the prompt adjusted in S302 as input and cause the generative AI of the generative device 200 to regenerate an image. The regenerative unit 203 obtains the regenerated image as the result of executing the regeneration processing in S303. After the regeneration processing in S303 is completed, the processing returns to the inappropriate generation result determination in S301. The determination unit 201 then determines whether the regenerated generation result (hereinafter also referred to as a regeneration result) is inappropriate. The information processing apparatus 100 repeats the processing in this manner, and ends the processing when it is ultimately determined that the generation result regenerated in S301 is not inappropriate.

### Effects of First Embodiment

In the first embodiment, it is determined whether a generation result obtained by generative AI is inappropriate. If the generation result is inappropriate, the input for regeneration is adjusted, and the same generative AI is used to perform regeneration. Therefore, it is not necessary to separately prepare a machine learning model of generative AI for regeneration. As a result, the first embodiment can suppress an increase in the number of models while reducing inappropriate generation results. In addition, the first embodiment can reduce the effort required to separately prepare a machine learning model for regeneration and to adjust the input. As a result, the first embodiment can prevent generation of inappropriate generation results and prevent users, such as children, from being exposed to them, as well as prevent unintentional infringement of the rights of others.

In the first embodiment, at least either a part of an input, such as a word that is a part of a prompt, or the number of inputs, such as the number of words, is adjusted. This makes it possible to achieve the above effects while suppressing an increase in the processing load.

In the first embodiment, the adjustment item is adjusted based on the similarity between the generation result and the input prompt. Thus, the accuracy of input adjustment can be improved.

In the first embodiment, the similarity is determined based on cosine similarity calculated based on a feature vector of the generation result and a feature vector of the input. Therefore, the similarity can be calculated more accurately.

In the first embodiment, the similarity between the generation result and the input is calculated after the generation result is preprocessed into the same text format as that of the input. Thus, the first embodiment enables more accurate calculation of the similarity.

In the first embodiment, the similarity is calculated from features extracted from a combination of a plurality of words included in the generation result and the input text. Therefore, the similarity can be calculated more accurately than when the similarity is calculated using words only.

### Modification 1

The first embodiment has been described regarding the case in which the generative device 200 outputs generated images as a generation result and a regeneration result, with a prompt as input. However, the generation result to be output may be other than an image.

For example, a generative device 200 according to modification 1 may generate videos as a generation result and a regeneration result, with a prompt as input. In this case, the determination unit 201 may determine whether the video that is the generation result is inappropriate, using a model trained using machine learning. Then, based on the determination result, the adjustment unit 202 may adjust the input by suppressing a part of the prompt in accordance with the similarity between features of the prompt input to the generative device 200 and features of an image of each frame of the video that is the generation result. The regenerative unit 203 may cause the generative device 200 to regenerate a video based on the input adjusted by the adjustment unit 202.

The generative device 200 may generate a generation result in the form of either audio or 3D data. The generative device 200 may also generate a generation result in the form of text, document, or the like including sentences and program source code. In addition, the generative device 200 may generate a summary combining text of a long sentence as input, or may generate a new sentence from a long sentence, or may generate a new image from images. The generative device 200 may generate an image representing a non-existent person from images, or may generate a color image from a black-and-white image. The generative device 200 may also receive an image and a prompt as input and generate an altered image. Note that the output format of the generative device 200 according to modification 1 is not limited to the above formats. Furthermore, the input may include not only a prompt, but also an element other than a prompt, as in the case where the input includes an image in addition to a text prompt.

According to modification 1, a regeneration result can be obtained in which an inappropriate generation result is suppressed even when the input and output of a task are video, audio, 3D data, text, or the like.

### Modification 2

In the first embodiment, the adjustment unit 202 adjusts the input to image-generating AI and thereby reduces the effort required to regenerate a generation result while suppressing an increase in the number of models, and suppresses inappropriate generation results. In modification 2, a configuration will be described in which whether to output at least either a generation result or a regeneration result is adjusted. Note that image generation through generative AI processing according to this modification will be described regarding a case where a prompt or the like that indicates generation condition information is input to a diffusion model to output a different image, as in the first embodiment.

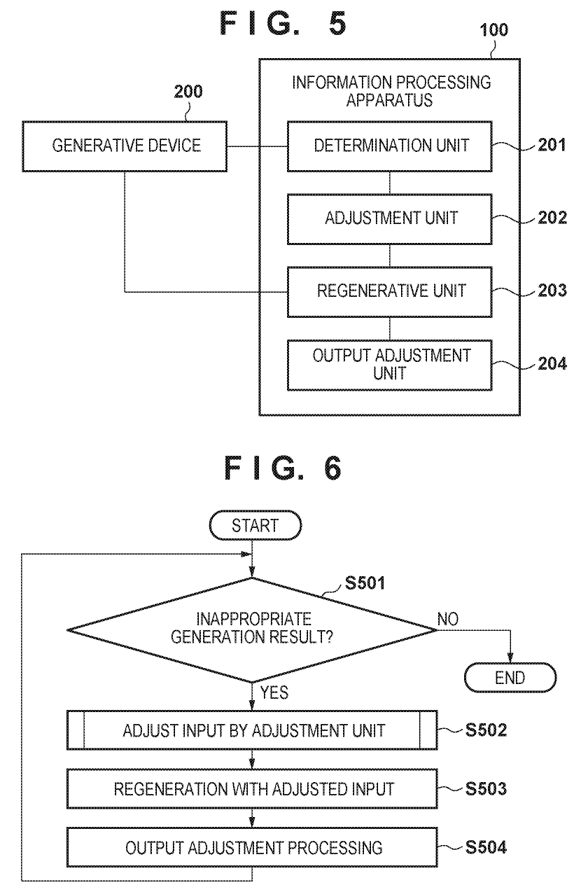

FIG. 5 is a block diagram illustrating functionality of an information processing apparatus 100 according to modification 2. The information processing apparatus 100 according to modification 2 includes a determination unit 201, an adjustment unit 202, a regenerative unit 203, and an output adjustment unit 204. The determination unit 201, the adjustment unit 202, and the regenerative unit 203 according to modification 2 are the same as those of the first embodiment, and the basic description thereof is omitted. The output adjustment unit 204, which has a configuration specific to modification 2, will be described.

The output adjustment unit 204 in modification 2 adjusts output of a regeneration result regenerated by the regenerative unit 203. Note that the output adjustment unit 204 may also adjust output of a generation result that is initially generated.

FIG. 6 is a flowchart illustrating a flow of processing for regenerating a generation result in modification 2. S501 to S503 of the regeneration processing in modification 2 are the same as S301 to S303 in FIG. 3 in the first embodiment, and the basic description thereof is omitted. Output adjustment processing in S504 executed by the output adjustment unit 204 differs from that of the first embodiment, and will therefore be described below in detail with reference to FIG. 6.

In the output adjustment processing in S504, the output adjustment unit 204 obtains a generation result from the generative device 200 and a regeneration result regenerated by the regenerative unit 203 based on the determination result in S501, and adjusts the output.

The output refers to execution of at least any of displaying, providing, presenting, and storing at least either the generation result or the regeneration result. For example, the output may include, causing the display unit 104 to display an image generated as the generation result or the like, storing an image as the generation result or the like in the external storage device 107, outputting audio as the generation result or the like from an external audio device, and vibrating an external device based on tactile information as the generation result or the like.

The adjustment of the output refers to controlling the output based on the determination result in S501. For example, the adjustment of the output refers to placing a restriction or making a change so as not to output at least either the generation result or the regeneration result. The output adjustment unit 204 may adjust the output at the time when the output adjustment unit 204 obtains either the generation result from the generative device 200 or the regeneration result by the regenerative unit 203 in S504. A configuration is also possible in which the output adjustment unit 204 does not adjust the output at the time when the generation result and the regeneration result are obtained, but adjusts the output before the regeneration processing ends and the generation result or the like is output. In this case, the output adjustment unit 204 may assign information (e.g., add a flag) indicating that the generation result and the regeneration result are output adjustment targets in S504, and adjust them at the time when the regeneration processing ends.

The output adjustment unit 204 adjusts the output by restricting the output of at least either the generation result or the regeneration result. For example, the output adjustment unit 204 may place a restriction so as not to display images other than images that are the generation result and regeneration result determined to be not inappropriate. In this case, the output adjustment unit 204 may adjust the output so as to display only appropriate images instead of the restricted images.

For example, if the determination unit 201 determines that either the generation result or the regeneration result is inappropriate in S501, the adjustment unit 202 adjusts the input in S502, and the regenerative unit 203 performs regeneration in S503. Thus, in S504, the output adjustment unit 204 obtains at least the original generation result from the generative device 200 and the regeneration result by the regenerative unit 203. However, if the information processing apparatus 100 displays the generation result when the regeneration processing ends, there are cases where all images that are generation results are displayed. In these cases, the user may be exposed to an image including a generation result determined to be inappropriate in S501. Therefore, in S504, the output adjustment unit 204 adjusts the output of the generation result and regeneration result determined to be inappropriate, thereby restricting images to be displayed.

As a restriction method, the output adjustment unit 204 may restrict all display of the generation result and the regeneration result. For example, consider the case where, even after the processing from S501 to S504 is repeated and the adjustment unit 202 repeats adjustment of the input and regeneration of the regenerative unit 203, the determination result from the determination unit 201 continues to be “inappropriate”. In this case, if the determination unit 201 determines that the regeneration result is inappropriate even after a predetermined number of repetitions (e.g., five times), the determination unit 201 discontinues the determination processing in S501 and ends the processing. In this case, the output adjustment unit 204 performs adjustment so as not to display the generation result and the regeneration result. Even if the determination unit 201 cannot perform the determination appropriately, or the adjustment unit 202 cannot perform the adjustment appropriately, the processing can be ended without unnecessary repetition.

In this case, the output adjustment unit 204 may restrict all display of the generation result and the regeneration result. Also, instead of displaying the output, the output adjustment unit 204 may store these results in the external storage device 107 that can be accessed only by an administrator (e.g., a guardian). If the processing is not completed appropriately, the output adjustment unit 204 notifies the administrator of it such that the administrator can manually check the generation result and the regeneration result stored in the external storage device 107. The administrator may visually check whether the generation result and the regeneration result are appropriate, and determine whether the user is to be allowed to use them. This makes it possible to prevent the user from being exposed to or inappropriately using an inappropriate generation result.

The output adjustment unit 204 may store the generation result and the regeneration result in the external storage device 107 that can be accessed only by the administrator, in accordance with the probability value of the determination result from the determination unit 201. For example, consider a case where the determination unit 201 determines whether the generation result or the like is inappropriate based on whether the probability value calculated by a model trained using machine learning exceeds a threshold value. In this case, the output adjustment unit 204 may store the generation result and the regeneration result in the external storage device 107 that is accessed only by the administrator, in accordance with the degree of deviation of the probability values from the threshold value. If the probability value slightly exceeds the threshold value, there is concern that the determination unit 201 will erroneously determine an inappropriate generation result to be not inappropriate, depending on the setting of the threshold value. Accordingly, if the probability value falls within a predetermined percentage range from the threshold value, the output adjustment unit 204 may store the generation result and the regeneration result in the external storage device 107 that can be accessed only by the administrator. Thus, even when the generation result and the regeneration result are determined to be not inappropriate, the administrator can check more accurately whether these results are inappropriate by visual inspection or the like. Regarding the probability value within the predetermined percentage range from the threshold value, for example, the probability value is in the range of 0.55 to 0.45 when the threshold value is 0.5 and the predetermined percentage is 10%.

If the regeneration processing is discontinued and ended as mentioned above, the output adjustment unit 204 may display alternative output without displaying the generation result and the regeneration result. The output adjustment unit 204 may, for example, display a reason for ending the processing in a pop-up on the screen. As an example, the output adjustment unit 204 may output a sentence such as: "Because the output was determined to be inappropriate, the input was adjusted and the regeneration processing was repeated. However, the results continued to be determined to be inappropriate, so the processing was discontinued and ended”.

The output adjustment unit 204 may display a word in the prompt input to the generative device 200 that was determined as an adjustment item in S502, as likely to be the cause of an inappropriate generation result. For example, if the word "bloody" in the prompt is determined to be inappropriate and adjusted in S502, the output adjustment unit 204 may display a message such as: "The word ‘bloody’ has been determined as inappropriate input, so please consider another expression". If the adjustment unit 202 finds one or more synonyms having low similarity to the word determined to be inappropriate and adjusted while determining the input adjusting method in S402, the output adjustment unit 204 may display these synonyms to recommend them in a similar display method.

The output adjustment unit 204 may output an image other than the generation result and the regeneration result as alternative output. For example, the output adjustment unit 204 may perform an image search based on a prompt, using filter functions such as a safety filter that eliminates harmful search results, and output the search results. This is because, when the determination unit 201 determines that the generated result and the regenerated result are inappropriate and these generated images are not intended by the user, it may be due to biased outputs caused by the data on which the generative device 200 was trained. In such cases, images retrieved by the search may be closer to an output result desired by the user. Thus, the output adjustment unit 204 can utilize them as reference information when the user reviews the input prompt. Further, when the generative device 200 can handle input of an image and a prompt, the output adjustment unit 204 can use images retrieved by the search and a prompt as input and thereby obtain a generation result from the generative device 200 based on the retrieved images. Note that, in addition to a safety filter function, the filter functions may include a function of searching images with license restrictions.

The above description has been given of an example in which the output adjustment unit 204 controls the output by restricting the output. Meanwhile, the output may be controlled by changing the output. For example, based on the determination result from the determination unit 201, the output adjustment unit 204 may change the output format when the regenerative unit 203 performs regeneration, and output the regeneration result.

The first embodiment has been described regarding the case where a generated image is received as a generation result from the generative device 200, and, as a result of the adjustment unit 202 adjusting the prompt, the regenerative unit 203 regenerates an image as a regeneration result. However, the regeneration targets are not limited to images. Here, a description will be given of a case where the regenerative unit 203 regenerates a sentence as a regeneration result.

For example, in the case where the determination unit 201 determines whether a generation result is inappropriate based on whether the probability value of a model trained using machine learning exceeds a threshold value, the output adjustment unit 204 may change the regeneration result based on the degree of deviation of the probability value from the threshold value. Regarding the degree of deviation, the determination unit 201 may determine whether the probability value is within a predetermined percentage range from the threshold value. This overlaps the already-described content, and will not be described here.

As for the method for regenerating a sentence, when the generative device 200 can change the output, the output adjustment unit 204 may add a prompt to change the output format. In addition, the output adjustment unit 204 may change an image to a sentence using a generative AI (e.g., image caption-generating AI) model separate from the generative device 200. As a result of the output adjustment unit 204 changing the generation result from an image to a sentence, the amount of information of the regeneration result is reduced. Thus, even when the determination unit 201 cannot accurately determine inappropriateness, it is possible to prevent the user from being exposed to inappropriate generation results or inappropriately using it. The change of the output format includes not only a change from an image to a sentence but also a change from a video to a sentence and from a video to an audio, for example.

In addition, the change of the output includes processing the generation result and the regeneration result. The processing includes altering an inappropriate area of the generation result. The processing in modification 2 includes image pixelation, blackout, image clipping, image synthesis, and the like. For example, if the determination unit 201 performs determination using a model trained using machine learning for a task of detecting inappropriate objects, the output adjustment unit 204 may process the generation result and the regeneration result based on the detection result. Since it is likely that the detection result corresponds to an area including an inappropriate object, the output adjustment unit 204 may perform image processing such as image pixelation on the inappropriate object area included in the detection result. The output adjustment unit 204 may also combine another image that is not inappropriate in the area corresponding to the detection result. The output adjustment unit 204 may perform processing (cropping etc.) to cut out an inappropriate area corresponding to the detection result to exclude this area from the generated image. By applying processing, the output adjustment unit 204 can change the generation result and the regeneration result to generation results that are not inappropriate, while minimizing changes.

As described above, in S504, the output adjustment unit 204 adjusts the generation result from the generative device 200 and the generation result regenerated by the regenerative unit 203, and then returns to the processing in S501 again.

According to modification 2, when a generation result is inappropriate, not only the input but also the output is adjusted, thereby allowing the user to check and use the generation result more safely.

### Modification 3

In modification 2, the output adjustment unit 204 adjusts the output of at least either the generation result from the generative device 200 or the regeneration result. The output adjustment unit 204 according to modification 3 may also adjust the output of the determination unit 201 and the adjustment unit 202. For example, in modification 2, when the output adjustment unit 204 adjusts the output, the output adjustment unit 204 displays another output instead of the generation result or the like from the generative device 200. Meanwhile, the output adjustment unit 204 according to modification 3 displays output based on the result from the determination unit 201 or the adjustment unit 202 as an alternative output. If a determination result and an adjustment result are results generated based on generative AI, it is possible that these results include an inappropriate generation result or the like. Consequently, if the generation result or the like is displayed as-is, it is possible that the user will be exposed to the inappropriate generation result or the like. Accordingly, when the determination result and the adjustment result are output by generative AI, the output adjustment unit 204 may restrict the output such that they are not displayed as alternate output.

In modification 3, when the determination unit 201 and the adjustment unit 202 respectively perform determination and adjustment using generative AI, the output adjustment unit 204 adjusts the output of the determination unit 201 and the adjustment unit 202. Thus, the user can be prevented from being exposed to inappropriate generation results or the like, thereby enabling safer use.

According to the present disclosure, inappropriate generation results can be suppressed.

### Other Embodiments

Although the embodiment and modifications have been described above, the present disclosure can be implemented in modes such as a system, an apparatus, a method, a program, or a recording medium (storage medium), for example. Specifically, the present disclosure may be applied to a system that is constituted by a plurality of devices (e.g., a host computer, an interface device, an image capture device, a web application etc.), or may be applied to an apparatus constituted by a single device.

It is needless to say that the object of the present disclosure is achieved by the following procedure. That is to say, a recording medium (or storage medium) that records a program code (computer program) of software that enables the functionality of the above-described embodiment is supplied to a system or apparatus. It is needless to say that such a storage medium is a computer-readable storage medium. The computer (or CPU or MPU) of the system or apparatus reads and executes the program code stored in the recording medium. In this case, the program code read from the recording medium realizes the functionality described in the above embodiment, and the recording medium having the program codes recorded thereon constitutes the present disclosure.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016286, filed February 3, 2025, which is hereby incorporated by reference herein in its entirety.

What is claimed is:

1. An information processing apparatus comprising:
a determination unit configured to determine whether a generation result from generative AI processing is inappropriate;
an adjustment unit configured to adjust an input to the generative AI processing based on a determination result of the determination; and
a regenerative unit configured to cause the generative AI processing to perform regeneration using the adjusted input to obtain a regeneration result.

2. The information processing apparatus according to claim 1,
wherein the determination unit determines whether the generation result is inappropriate by using at least one of a trained model trained using machine learning in advance and a generative AI model trained using machine learning in advance.

3. The information processing apparatus according to claim 1,
wherein the adjustment unit determines at least one of an adjustment item and an adjustment method for the input.

4. The information processing apparatus according to claim 3,
wherein the adjustment unit adjusts at least one of a part of the input and the number of inputs as the adjustment item.

5. The information processing apparatus according to claim 3,
wherein the adjustment unit determines the adjustment item based on a similarity between the generation result and the input.

6. The information processing apparatus according to claim 3,
wherein the adjustment unit adjusts the adjustment item based on at least one of a user attribute, location information, a date and time, and meta information.

7. The information processing apparatus according to claim 3,
wherein the adjustment unit adjusts the adjustment item based on a database related to an inappropriate generation result.

8. The information processing apparatus according to claim 3,
wherein the adjustment unit determines at least one of suppression and change of the adjustment item as the adjustment method.

9. The information processing apparatus according to claim 1,
wherein the generative AI processing generates at least one of an image, a video, an audio, 3D data, and text.

10. The information processing apparatus according to claim 1, further comprising an output adjustment unit configured to adjust an output of at least one of the generation result and the regeneration result.

11. The information processing apparatus according to claim 10,
wherein the output adjustment unit adjusts the output by executing at least one of restriction and change of an output of at least one of the generation result and the regeneration result.

12. The information processing apparatus according to claim 10,
wherein the output adjustment unit restricts an output of at least one of the generation result and the regeneration result, and executes at least one of storage of the restricted output in a storage device and display of an alternative output instead of the restricted output.

13. The information processing apparatus according to claim 10,
wherein the output adjustment unit executes at least one of change of a form of the output of at least one of the generation result and the regeneration result, and processing of the output.

14. The information processing apparatus according to claim 10,
wherein the output adjustment unit adjusts an output of the determination unit and an output of the adjustment unit.

15. The information processing apparatus according to claim 5,
wherein the adjustment unit calculates the similarity based on a feature of the generation result and a feature of the input.

16. The information processing apparatus according to claim 15,
wherein the adjustment unit calculates the similarity based on a cosine similarity between a vector representing the feature of the generation result and a vector representing the feature of the input.

17. The information processing apparatus according to claim 16,
wherein the adjustment unit executes preprocessing on the generation result to generate text, obtains the input that is text, and calculates the cosine similarity based on a feature of a word included in the text.

18. The information processing apparatus according to claim 17,
wherein the adjustment unit calculates the cosine similarity based on at least one of the word and a combination of words included in the text.

19. An information processing method comprising:
determining whether a generation result from generative AI processing is inappropriate;
adjusting an input to the generative AI processing based on a determination result of the determination; and
causing the generative AI processing to perform regeneration using the adjusted input to obtain a regeneration result.

20. A non-transitory computer-readable storage medium storing a computer program that, when read and executed by a computer, causes the computer to function as:
a determination unit configured to determine whether a generation result from generative AI processing is inappropriate;
an adjustment unit configured to adjust an input to the generative AI processing based on a determination result of the determination; and
a regenerative unit configured to cause the generative AI processing to perform regeneration using the adjusted input to obtain a regeneration result.
